(19) United States
(12) Patent Application Publication
(10) Pub. No.: US 2019/0066548 A1
(43) Pub. Date: Feb. 28, 2019

(54) VEHICLE EMBLEM ASSEMBLY

(71) Applicant: Ford Global Technologies, LLC, Dearborn, MI (US)

(72) Inventors: Paul Kenneth Dellock, Northville, MI (US); Venkatesh Krishnan, Canton, MI (US); Ulrich Stuhec, Ann Arbor, MI (US); Stuart C. Salter, White Lake, MI (US); Harry Lobo, Canton, MI (US)

(21) Appl. No.: 15/683,145

(22) Filed: Aug. 22, 2017

(51) Int. Cl. G09F 13/22; B60Q 1/50; B60Q 1/26; G09F 13/16; G09F 21/04

(52) U.S. Cl. CPC G09F 13/22; B60Q 1/50; G09F 2013/227; G09F 13/16; G09F 21/048; B60Q 1/268

(57) ABSTRACT

A window assembly is provided herein. The window assembly includes an emblem assembly configured to couple to a window of a vehicle. An indicia is disposed within the emblem assembly signifying a first operational mode of the vehicle. A reflective layer is disposed on the emblem assembly. The indicia is visible when the vehicle is operating in the first operational mode and non-visible in a second operational mode.

### FIELD OF THE INVENTION

The present disclosure generally relates to vehicle decals, and more particularly, to an illuminable emblem assembly for notifying proximate vehicles and persons of a mode of the vehicle.

### BACKGROUND OF THE INVENTION

Emblem assemblies are commonly employed on vehicles to display a vehicle manufacturer's logo, a company's logo, or other graphic display. For some vehicles, it may be desirable to have a more prominent emblem assembly to notify a mode of the vehicle.

### SUMMARY OF THE INVENTION

According to one aspect of the present disclosure, a vehicle is disclosed. The vehicle includes an emblem assembly configured to couple to a window of a vehicle. An indicia is disposed within the emblem assembly signifying a first operational mode of the vehicle. A reflective layer is disposed on the emblem assembly. The indicia has a first level of visibility when the vehicle is operating in the first operational mode and a second, lower level of visibility in a second operational mode.

According to another aspect of the present disclosure, an emblem assembly for a vehicle is disclosed. The emblem assembly includes an indicia signifying a first operational mode of the vehicle. A reflective layer is disposed on the indicia. The indicia is more visible when the vehicle is operating in the first operational mode and less visible in a second operational mode.

According to yet another aspect of the present disclosure, an emblem assembly for a vehicle is disclosed. The emblem assembly includes a light source optically coupled to a light guide. An indicia is operably coupled with the light guide. A controller is configured to activate the light source when the vehicle is disposed in a first operational mode and deactivate the light source when the vehicle is operated in a second operational mode.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure;

FIG. 2 is a side perspective view of an emblem assembly disposed on a window of a vehicle;

FIG. 3 is a block diagram of an exemplary autonomous vehicle system, according to some examples;

FIG. 4 is a block diagram of a vehicle having the emblem assembly, according to some examples;

FIG. 5 is a cross-sectional view of the emblem assembly taken along the line V-V of FIG. 2, according to some examples, having a light guide disposed between an outer panel and an inner panel;

FIG. 6 is a cross-sectional view of the emblem assembly taken along the line V-V of FIG. 2, according to some examples, including a light guide having a tapered core disposed between the outer panel and the inner panel;

FIG. 7 is an enhanced side perspective view of area VII of FIG. 2 illustrating the emblem assembly on the vehicle, according to some examples;

FIG. 8 is an enhanced side perspective view of area VII of FIG. 2 illustrating the emblem assembly in an illuminated state, according to some examples;

FIG. 9 is a front perspective view of the vehicle having the emblem assembly disposed on a windshield, according to some examples; and

FIG. 10 is a rear perspective view of the vehicle having the emblem assembly on a rear window of the vehicle, according to some examples.

### DETAILED DESCRIPTION OF THE PREFERRED EXAMPLES

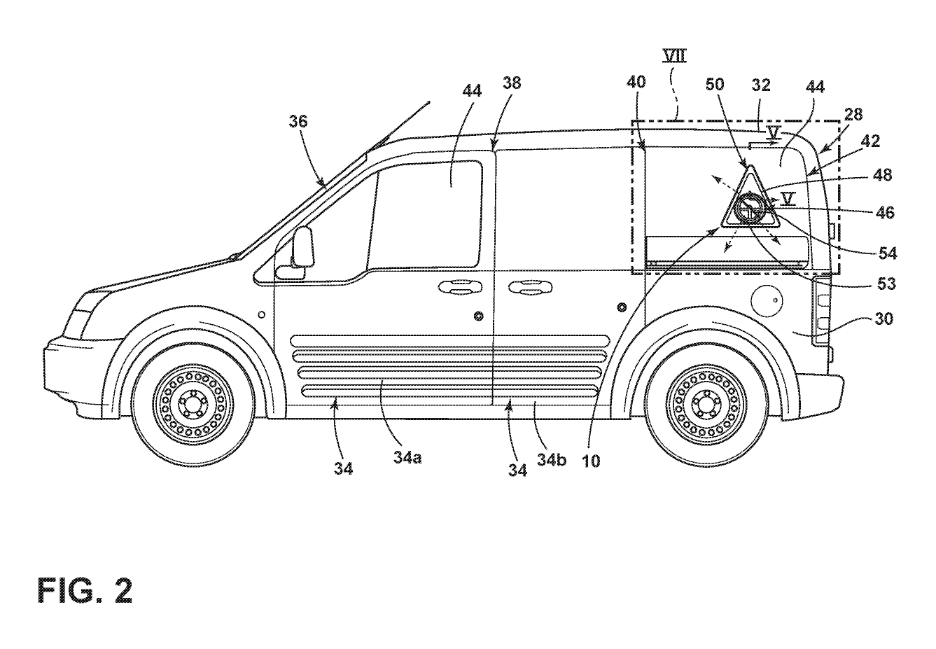

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes an illuminable emblem assembly for a vehicle. The emblem assembly may notify proximate vehicles and/or persons of a vehicle mode. The emblem assembly may be illuminated by one or more light sources therein. The emblem assembly may further employ one or more phosphorescent and/or luminescent structures to luminesce in response to predefined events. The one or more luminescent structures may be configured to convert excitation light received from an associated light source and re-emit the light at a different wavelength generally found in the visible spectrum.

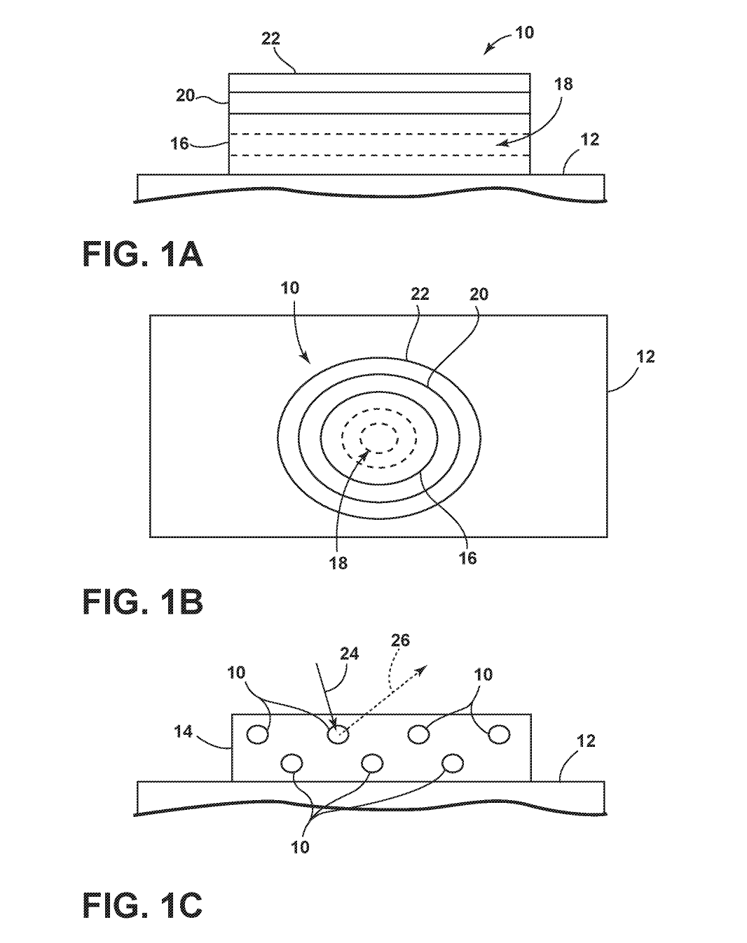

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emitted from one or more light sources 52 (FIG. 2). According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material 18 known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light source 52). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any one or more light sources 52 that emit the excitation light 24, including, but not limited to, natural light sources (e.g., the sun) and/or any artificial one or more light sources 52. The periodic absorption of the excitation light 24 from any excitation source may provide for a substantially sustained charge of the long-persistence luminescent material 18 to provide for consistent passive illumination. In various examples, a light sensor may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example, doped di-silicates, or any other compound that is capable of emitting light for a period of time once the excitation light 24 is no longer present. The long-persistence luminescent material 18 may be doped with one or more ions, which may correspond to rare earth elements, for example, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Referring to FIG. 2, a vehicle 28 includes a body 30 and a roof 32. The body 30 may include a plurality of doors 34. The doors 34 include a driver door 34a and a passenger door 34b. The vehicle 28 further includes an A-pillar 36, a B-pillar 38, a C-pillar 40, and a D-pillar 42 that support the roof 32. It will be appreciated, however, that the vehicle 28 may have any number of longitudinally disposed pillars 36, 38, 40, 42 without departing from the scope of the present disclosure. Furthermore, the vehicle 28 is depicted as a van, but it will be understood that the vehicle 28 may be a truck, sport utility vehicle, sedan, or any other type of vehicle 28 without departing from the teachings provided herein.

A window 44 may be disposed between any of the pillars 36, 38, 40, 42. The window 44 may be made of a glass, a glazing, and/or any other transparent and/or translucent material. The vehicle 28 further includes an emblem assembly 46, which may be disposed on, or within, one or more of the windows 44 of the vehicle 28 and has one or more indicia 48 therein. For example, the indicia 48 may define a symbol to designate when the vehicle 28 is in an autonomous driving mode. Accordingly, the emblem assembly 46 may notify proximate persons and vehicles of the autonomous mode of the vehicle 28. Accordingly, the emblem assembly 46 may provide a visual identification to distinguish the vehicle 28 from other vehicles that are under a manual operational mode. It will be appreciated that the emblem assembly 46 may additionally, and/or alternatively, be disposed on any other portion of the vehicle 28, such as, but not limited to, any other interior and/or exterior portion of the vehicle 28. In some examples, the emblem assembly 46 may define any other practicable symbol to notify proximate vehicles and persons of any other mode of the vehicle 28. For example, while the vehicle 28 is in a learning and/or programming mode, the emblem assembly 46 may define an “L,” include “LEARNING,” and/or any other indication of the mode of the vehicle 28.

In some examples, the emblem assembly 46 may include a reflective material 50 that may increase visibility of the emblem assembly 46 under low light conditions. With reflective materials 50, light rays are reflected from the assembly 46 and can include arrays of randomly oriented micron diameter spheres, close packed cube-corner (prismatic) arrays, or any other practicable reflective material 50 known in the art.

As will be discussed in further detail below, in some examples, the emblem assembly 46 may also include one or more light sources 52 (FIG. 2) to further provide visibility of the emblem assembly 46. The indicia 48 may be defined by the luminescent structure 10 and may be configured to luminesce in response to receiving excitation light 24 emanated from the light source 52. The luminescent structure 10 may be generally non-visible when in a non-excited state. According to some examples, the luminescent structure 10 confers any desired information laterally outward (i.e., vehicle 28 side-to-side), forwardly of, and/or rearwardly of the vehicle 28. For example, the indicia 48 may define a notification symbol that may be indicative of a operational mode of the vehicle 28.

With further reference to FIG. 2, according to some examples, the indicia 48 define a graphic that illustrates a steering wheel 53 and a line therethrough 54 to indicate that the vehicle 28 is in an autonomous operational mode. The emblem assembly 46 may be attached to the vehicle 28 while being operated in an autonomous mode and/or illuminated in such circumstances. The indication of the driving mode may alert and/or notify proximate vehicles and persons of the operational mode of the vehicle 28. As provided above, any operational mode may be provided within the emblem assembly 46, such as an autonomous mode, a learning mode, and/or a manually operated mode of the vehicle 28.

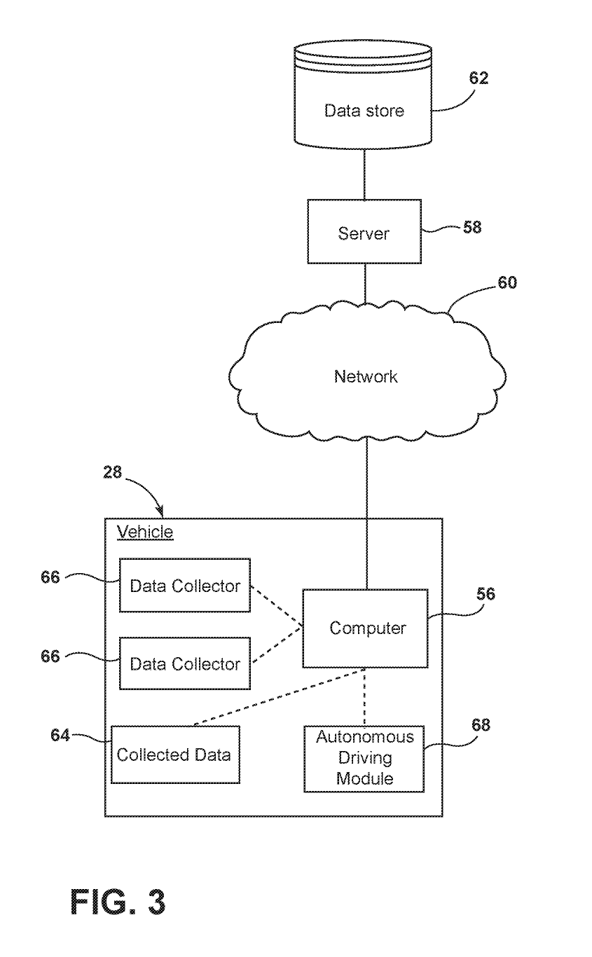

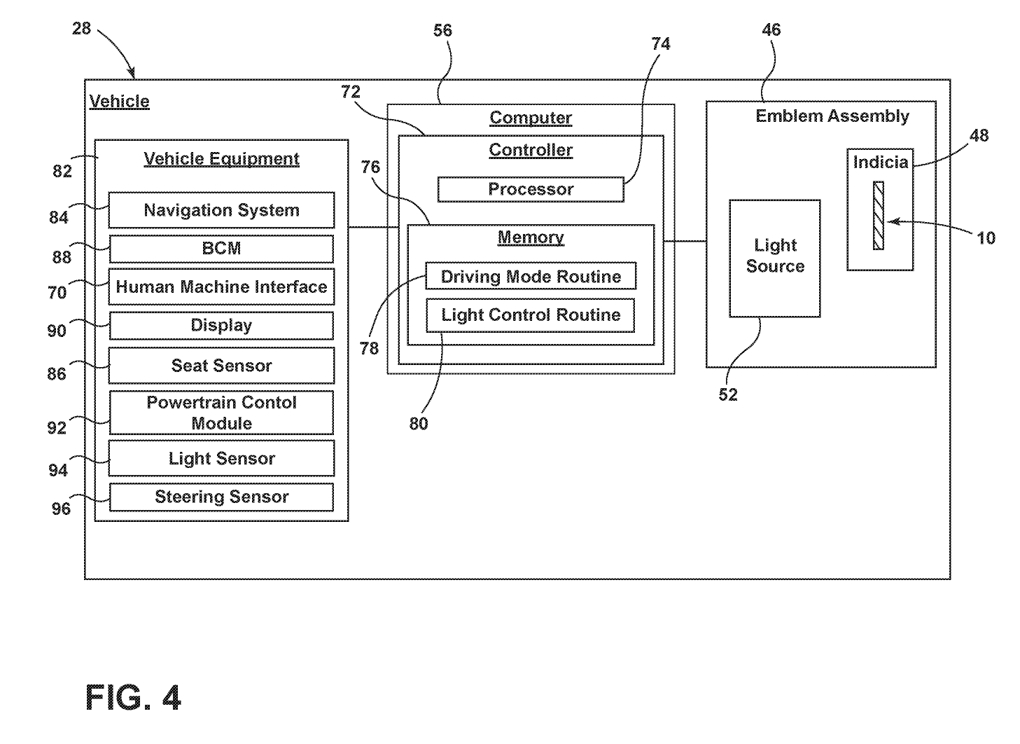

Referring to FIGS. 3 and 4, the vehicle 28 may be a manually operated vehicle (i.e. using a human driver) or may be autonomously driven by an onboard computer 56. Additionally, or alternatively, the vehicle 28 may be remotely controlled (e.g., via an operator located in a different location). In autonomous examples, one of which is exemplarily illustrated in FIG. 3, the computer 56 may be configured for communicating with one or more remote sites such as a server 58 via a network 60. The one or more remote sites may include a data store 62. The vehicle 28, including the computer 56, is configured to receive information, e.g., collected data 64, from one or more data collectors 66 related to various components of the vehicle 28, e.g., a steering wheel, brake pedal, accelerator pedal, gearshift lever, etc. The computer 56 generally includes an autonomous driving module 68 that includes instructions for autonomously, i.e., without some, or any, operator input, operating the vehicle 28, including possibly in response to instructions received from the server 58. Further, the computer 56, e.g., in the module 68, generally includes instructions for receiving data, e.g., from one or more data collectors 66 and/or a human machine interface (HMI) 70, such as an interactive voice response (IVR) system, a graphical user interface (GUI) including a touchscreen or the like, etc.

By determining driver characteristics and/or vehicle operating conditions, the module 68 may determine an appropriate control or controls to be applied to one or more vehicle components. For example, the module 68 may determine whether and when a steering wheel should be moved to mimic or approximate vehicle steering being conducted as part of an autonomous driving operation, e.g., autonomous driving according to instructions from the server 58 and/or the module 68.

The vehicle 28 includes a vehicle computer 56 that generally includes a controller 72 having a processor 74 and a memory 76, the memory 76 including one or more forms of computer-readable media, and storing instructions executable by the processor 74 for performing various operations. Further, the computer 56 may include more than one computing device, e.g., controllers 72 or the like included in the vehicle 28 for monitoring and/or controlling various vehicle components, e.g., an engine control unit (ECU), transmission control unit (TCU), etc. The computer 56 is generally configured for communications on a controller area network (CAN) bus or the like. The computer 56 may also have a connection to an onboard diagnostics connector (OBD-II). Via the CAN bus, OBD-II, and/or other wired or wireless mechanisms, the computer 56 may transmit messages to various devices in the vehicle 28 and/or receive messages from the various devices, e.g., controllers 72, actuators, sensors, electronic devices, etc., including data collectors 66. In addition, the computer 56 may be configured for communicating with the network 60, which, may include various wired and/or wireless networking technologies, e.g., cellular, Bluetooth, wired and/or wireless packet networks, etc.

The controller 72 may be a dedicated or shared controller and may include the processor 74 and memory 76, according to some examples. It should be appreciated that the controller 72 may include control circuitry such as analog and/or digital control circuitry. Logic is stored within memory 76 and executed by the processor 74 for processing the various inputs and controlling the light source 52, as described herein. The memory 76 may include one or more routines, such as a driving mode routine 78 and/or a light control routine 80. According to some examples, the driving mode routine 78 may determine whether the vehicle 28 is being operated in under an autonomous operation and/or a manual operation. The light control routine 80 may illuminate the light source 52 in a plurality of wavelengths based on the operational mode of the vehicle 28.

Instructions may be stored in and executed by the computer 56 in the autonomous driving module 68. Using data received in the computer 56, e.g., from the data collectors 66, the server 58, etc., the module 68 may control various vehicle 28 components and/or operations without a driver to operate the vehicle 28. For example, the module 68 may be used to regulate vehicle speed, acceleration, deceleration, steering, operation of components such as lights, windshield wipers, etc. Further, the module 68 may include instructions for evaluating information received in the computer 56 relating to vehicle 28 operator characteristics, e.g., from the HMI 70 and/or the data collectors 66.

The data collectors 66 may include a variety of vehicle equipment 82. For example, various controllers 72 in the vehicle 28 may operate as data collectors 66 to provide data 64 via the CAN bus, e.g., data 64 relating to vehicle speed, acceleration, etc. Further, sensors or the like, global positioning system (GPS) equipment, navigation systems 84, etc., could be included in the vehicle 28 and configured as data collectors 66 to provide data directly to the computer 56, e.g., via a wired or wireless connection. Sensor data collectors 66 could include mechanisms such as RADAR, LIDAR, sonar, etc. sensors that could be deployed to measure a distance between the vehicle 28 and other vehicles or objects. Yet other sensor data collectors 66 could include cameras, breathalyzers, motion detectors, etc., i.e., data collectors 66 to provide data for evaluating a condition or mode of a vehicle 28 operator. In addition, the data collectors 66 may include sensors to detect a position, change in position, rate of change in position, etc., of vehicle components such as a steering wheel, brake pedal, accelerator, gearshift lever, etc.

The memory 76 of the computer 56 generally stores the collected data 64. The collected data 64 may include a variety of data collected in the vehicle 28. Examples of collected data 64 are provided above, and moreover, the data 64 is generally collected using the one or more data collectors 66, and may additionally include data calculated therefrom in the computer 56, and/or at the server 58. In general, the collected data 64 may include any data that may be gathered by a collection device and/or computed from such data 64. For example, the collected data 64, as mentioned above, may include data concerning a position, change in position, rate of change in position, etc., of the vehicle 28 components such as a steering wheel, brake pedal, accelerator, gearshift lever, etc.

The network 60 represents one or more mechanisms by which a vehicle computer 56 may communicate with a remote server 58. Accordingly, the network 60 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 60 include wireless communication networks (e.g., using Bluetooth, IEEE 802.11, etc.), local area networks (LAN) and/or wide area networks (WAN), including the Internet, providing data communication services.

The server 58 may be one or more computer servers, each generally including at least one processor 74 and at least one memory, the memory storing instructions executable by the processor 74, including instructions for carrying out various steps and processes. The server 58 may include or be communicatively coupled to a data store 62 for storing the collected data 64, as well as parameters for evaluating operator input, e.g., parameters for a specific vehicle operator, a specific vehicle 28, particular weather or other environmental conditions, etc. Further, the server 58 may store information related to multiple vehicles 28, traffic conditions, weather conditions, etc., within a geographic area, with respect to a particular road, city, etc. The server 58 could also be configured to provide drive-by-wire instructions to vehicles 28 in an autonomous driving area, e.g., a road, etc., such as an “all stop” instruction for all vehicles 28 to stop, a speed restriction, a lane restriction, etc.

With further reference to FIGS. 3 and 4, the emblem assembly 46 may include one or more light sources 52 that illuminate the one or more indicia 48 of the emblem assembly 46, which may be defined by one or more luminescent structures 10. In response, the luminescent structures 10 may be configured to convert excitation light 24 received from the associated light source 52 into light having a wavelength in the visible spectrum. In some examples, a plurality of luminescent structures 10 may luminescence in response to a different wavelength of excitation light emitted from the light source 52. Accordingly, one or more indicia 48 may independently and/or contemporaneously luminesce.

In operation, the emblem assembly 46 may signify an operational mode of the vehicle 28. For example, the emblem assembly 46 may be removably attached to the vehicle 28 when the vehicle 28 is operated in an autonomous mode and removed from the vehicle 28 when the vehicle 28 is under manual operation. Moreover, the emblem assembly 46 may be disposed on the vehicle 28 and illuminated in one mode while unilluminated in the other in order to notify proximate vehicles and persons about the operational mode of the vehicle 28. Furthermore, the emblem assembly 46 may be non-visible in an unilluminated state and visible once illuminated by the one or more light sources 52. In some examples, the emblem assembly 46 may have a first visibility level when the vehicle is operated in a first operational mode, such as an autonomous mode, that is greater than a second visibility level that is visible when the vehicles is operated in a second operational mode.

With continued reference to FIGS. 3 and 4, the controller 72 may communicate with the vehicle equipment 82 to receive information and illuminate the light source 52 based on the information. In the depicted examples, the vehicle equipment 82 includes the navigation system 84, a body control module (BCM) 88, the HMI 70, a display 90, a powertrain control module (PCM) 92, a light sensor 94, a steering sensor 96, and/or a seat sensor 86, each of which provides information to the controller 72 that may be used to determine the operation of the emblem assembly 46. For example, the navigation system 84 may provide the controller 72 with information related to the progress of a trip (e.g., ETA, distance, etc.). The navigation system 84 may also cooperate with the emblem assembly 46 such that the emblem assembly 46 is illuminated as the vehicle 28 begins to operate and/or move in an autonomous mode. The BCM 88 and/or PCM 92 may provide the controller 72 with information related to the vehicle 28 such as a door status (e.g., locked/unlocked), a seat belt status (e.g., buckled/unbuckled), a vehicle speed, etc. to determine whether a person is disposed within the vehicle 28 and/or operating (or capable of operating) the vehicle 28.

With further reference to FIGS. 3 and 4, the vehicle 28 may additionally include the HMI 70 that may be used for controlling a plurality of functions within the vehicle 28, including, but not limited to, air conditioning settings, seat settings, sound settings, and/or navigational settings. The HMI 70 may also include a display 90 that may display any desired information about the settings and/or any other information about the vehicle 28. The display 90 may also provide any desired information about the emblem assembly 46. Moreover, the display 90 may provide information pertaining to the current trip while the vehicle 28 is operated in an autonomous mode.

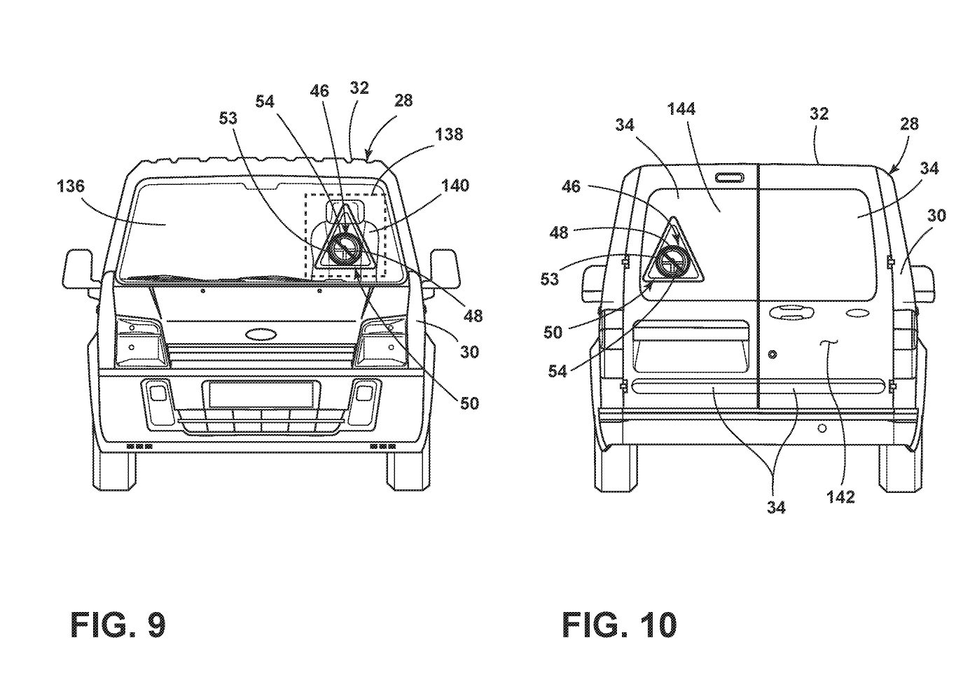

The seat sensor 86, which includes, but is not limited to, any type of proximity sensor, seat airbag sensor, pressure sensor, etc., may be utilized for initiating illumination of the emblem assembly 46. For example, if the occupant is not disposed on the driver's seat 140 (FIG. 9), the emblem assembly 46 may illuminate to indicate the lack of a person within the vehicle 28.

A light sensor 94 may be utilized for varying the intensity of excitation light 24 emitted from the light source 52. The light sensor 94 may also provide information to the controller 72 for activating the light source 52 based on the environmental light level. For example, the light source 52 may be activated in low light conditions and when the vehicle 28 is operating in a mode that is indicated by the emblem assembly 46. The light sensor 94 may be integrated into the vehicle 28 or into the emblem assembly 46. Moreover, the intensity of excitation light 24 may additionally, or alternatively, be varied with the initiation of the vehicle's headlights.

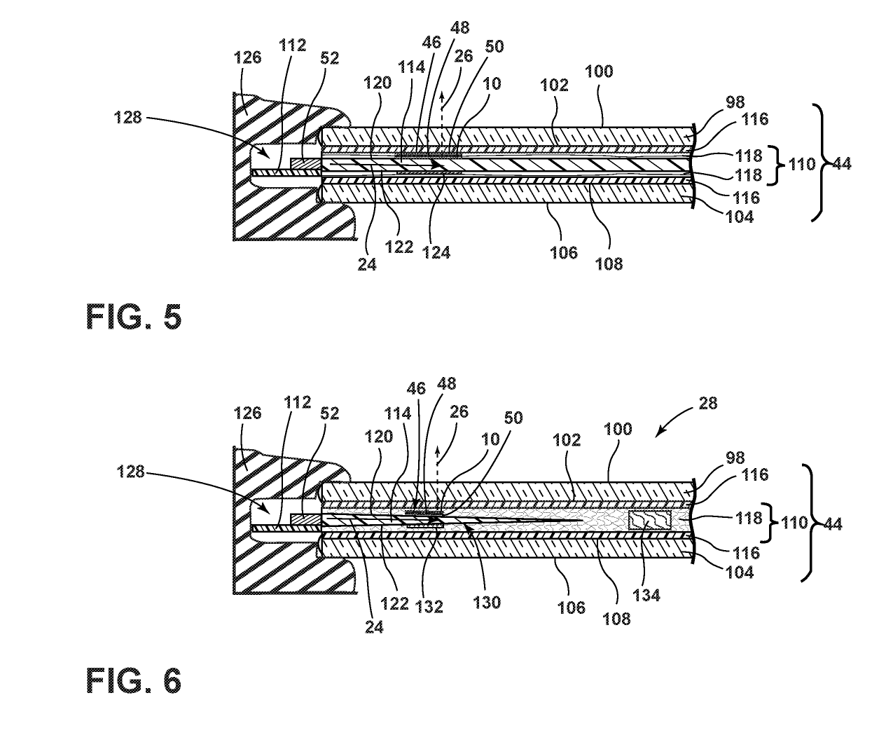

Referring to FIGS. 5 and 6, the window 44 includes a first or outer transparent and/or translucent panel 98. The outer panel 98 has a first side 100 or outer surface and a second side 102 or inner surface. The window 44 may also include a second or inner transparent and/or translucent panel 104. The inner panel 104 has a third side 106 or outer surface and a fourth side 108 or inner surface. The outer panel 98 and inner panel 104 are spaced from each other by a gap 110 therebetween of a predetermined thickness. It will be appreciated that each component of the window 44 provided herein may be of any thickness without departing from the scope of the present disclosure.

The luminescent structure 10 may be disposed within the gap 110, or otherwise arranged on the window 44. The light source 52, which may be disposed on a printed circuit board (PCB) 112 is operably, or optically, coupled with a light guide 114 that may also be disposed within the gap 110. The light source 52 may include any form of light source. For example fluorescent lighting, light emitting diodes (LEDs), organic LEDs (OLEDs), polymer LEDs (PLEDs), laser diodes, quantum dot LEDs (QD-LEDs), solid-state lighting, a hybrid of these or any other similar device, or any other form of lighting. The light guide 114 is configured to direct excitation light 24 towards the emblem assembly 46. In some examples, the emblem assembly 46 may employ additional light sources 52 and/or light guides for illuminating the luminescent structure 10, and consequently, indicia 48 independently. For example, the indicia 48 may form turn signals that may be illuminated by any of the light sources 52.

Referring to FIGS. 5 and 6, the light guide 114 is disposed inwardly of the outer panel 98 and may include the luminescent structure 10 on a portion thereof. The light guide 114 is a substantially transparent or translucent guide suitable for transmitting light (e.g., excitation light 24) and is operably coupled with the light source 52. The light source 52 may be provided on the flexible or rigid PCB 112 that is secured to the vehicle 28.

The light guide 114 may be formed from a rigid material that is comprised of a curable substrate such as a polymerizable compound, a mold in clear (MIC) material or mixtures thereof. Acrylates are also used for forming rigid light pipes, as well as poly methyl methacrylate (PMMA), which is a known substitute for glass. A polycarbonate material may also be used in an injection molding process to form the rigid light guide 114. Further, the light guide 114 may be a flexible light guide, wherein a suitable flexible material is used to create the light guide 114. Such flexible materials include urethanes, silicone, thermoplastic polyurethane (TPU), or other like optical grade flexible materials. Whether the light guide 114 is flexible or rigid, the light guide 114, when formed, is substantially optically transparent and/or translucent and capable of transmitting excitation light 24. The light guide 114 may be referred to as a light pipe, a light plate, a light bar or any other light carrying or transmitting substrate made from a clear or substantially translucent material.

A light-blocking layer 116 may be adhered to, printed on, and/or otherwise disposed on the outer panel 98, the inner panel 104, and/or the light guide 114 through an adhesive layer 118. The adhesive layer 118 may be an optically clear adhesive. As used herein, the term “optically clear” refers to an adhesive that has a high light transmittance over at least a portion of the visible light spectrum (about 400 to about 700 nanometers), and that exhibits low haze. Both the luminous transmission and the haze can be determined using, for example, the method of ASTM-D 1003-95. In some examples, the adhesive has about 10% haze or less, particularly about 5% haze or less, and more particularly about 2% haze or less.

In operation, the light source 52 may illuminate the emblem assembly 46 when a predefined operational mode is commenced by the vehicle 28. In some examples, the luminescent structure 10, which may be disposed on and/or within the light guide 114 and/or the light-blocking layer(s) 116, is formulated to become excited upon receiving excitation light 24 of a specific wavelength from the light source 52 that is directed through the light guide 114. As a result, the excitation light 24 undergoes an energy conversion process and is re-emitted at a different wavelength that may be transmitted through the light-blocking layer(s) 116.

The luminescent structure 10 may be disposed on a first side 120 of the light guide 114, such as the outwardly facing side of the light guide 114. An opposing, second side 122 of the light guide 114 may include optics 124 thereon for assisting in directing excitation light 24 towards the luminescent structure 10. The optics 124 may be etched, molded, coupled to, or otherwise disposed on the light guide 114 such that additional light is directed towards the luminescent structure 10. The optics 124, according to some examples, are faintly etched onto the light guide 114 such that the optics 124 are not readily visible (i.e., easily noticeable at distances over two feet) to an onlooker of the emblem assembly 46.

Still referring to FIGS. 5 and 6, a seal 126 may be disposed around a periphery of the window 44. According to some examples, the seal 126 may define a cavity 128 that may house the light source 52. The seal 126 is capable of carrying compression loads without being unduly deformed relative to its normal sealing position.

Referring to FIG. 6, the light guide 114 may have a tapered core 130 to direct excitation light 24 that is emitted from the light source 52 towards the luminescent structure 10. The tapered core 130 decreases in thickness in the direction in which the excitation light 24 is transmitted. As a result, the amount of excitation light 24 transmitted therethrough is increased. By using this arrangement, the diameter of the light beam, which originally is large, can be decreased prior to transmission through the light guide 114, simultaneously increasing the power density of the excitation light 24 towards the luminescent structure 10 disposed on the light guide 114 and/or the light-blocking layer(s) 116. A dot pattern, a microstructure 132, and/or any other etched pattern is formed on the opposing surface of the light guide 114 to diffuse light incident within the light guide 114 and further direct excitation light 24 towards the luminescent structure 10.

In some examples, the thickness of the light-blocking layer(s) 116 may be non-uniform to compensate for various geometries of the light guide core 130 such that the outer and inner panels 98, 104 are separated from one another at a substantially constant distance. Additionally, or alternatively, the adhesive layer may vary in thickness to compensate for variances in thickness of the light-blocking layer(s) 116, the light guide 114, the optics 124, the luminescent structure 10, and/or any other component disposed within the gap 110. Moreover, in some examples, a spacer 134 may be utilized to maintain the gap 110 between the outer panel 98 and the inner panel 104.

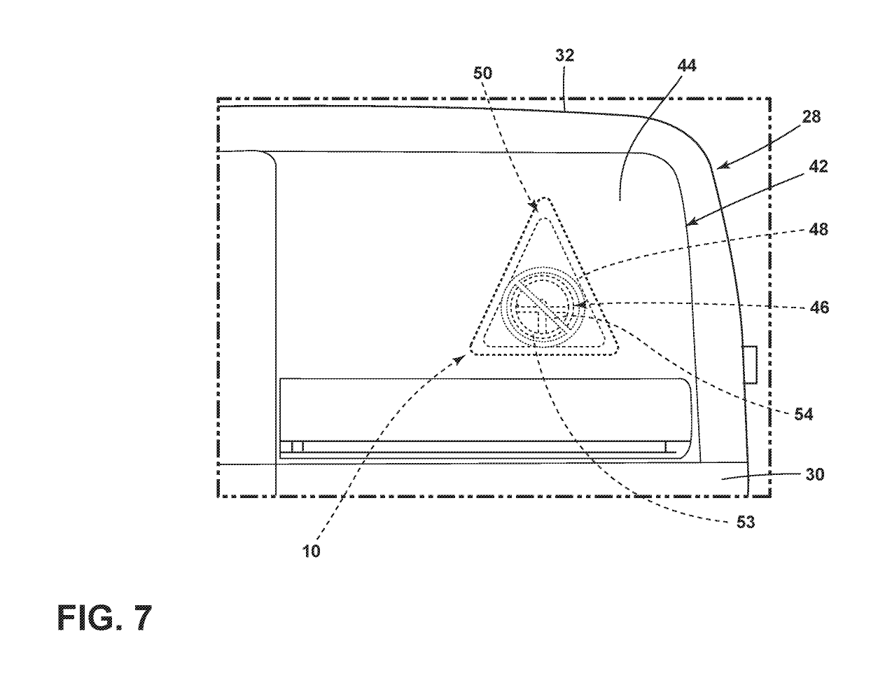

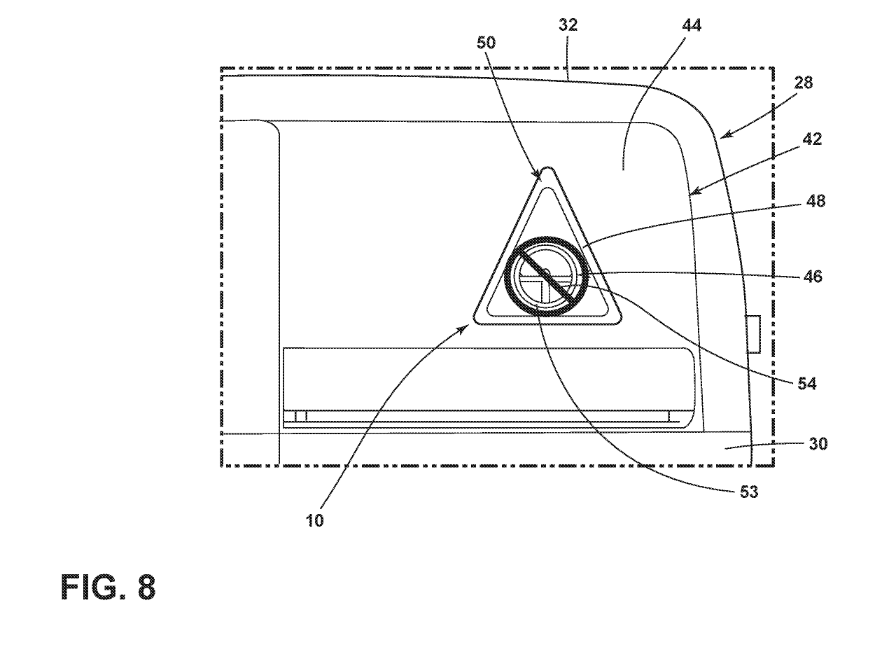

Referring to FIGS. 7 and 8, the emblem assembly 46 may notify proximate vehicles and persons of the operational mode of the vehicle 28 (i.e., whether the vehicle 28 is under manual or autonomous operation). It will be appreciated, however, that the indicia 48 may additionally, or alternatively, form turn signals, insignia indicating a vehicle manufacturer, a user defined message, an image, a trademark, and/or any other desired information. Moreover, the light source 52 may emit a plurality of wavelengths of excitation light 24 that excite unique luminescent structures 10 such that more than one set of indicia 48 may independently luminesce from the emblem assembly 46 to provide a wide array of notifications.

With further reference to FIGS. 7 and 8, non-concealed components of the emblem assembly 46, such as the outer panel 98 (FIG. 6), light-blocking layer(s) 116 (FIG. 6), light guide 114 (FIG. 6), and the indicia 48, may be substantially transparent, translucent, and/or not readily visible when the light source 52 is unilluminated, as shown in FIG. 7. When a corresponding light source 52 is illuminated, the luminescent structure 10 may be visible, as shown in FIG. 8.

In examples incorporating a luminescent structure 10, a wide range of luminescent materials 18 that luminesce in response to UV light, or any other wavelength of excitation light 24, may be substantially non-visible in an unexcited state, each of which may be utilized without departing from the scope of the present disclosure. Upon illumination of an associated light source 52, the luminescent material 18 may luminesce in the visible portion of the light spectrum. According to some examples, the luminescent structure 10 may include a mixture of UV light and infrared (IR) light excitable luminescent materials 18 therein that are capable of exciting the luminescent structure 10.

In some examples, the light source 52 may emit significant intensities of light that is transmitted through the light guide 114. The light-blocking layer(s) 116 maintain substantially all of the emitted excitation light 24 from exiting through the outer panel 98 and/or the inner panel 104. The significant intensities of light may be utilized to ensure that the luminescent structure 10 is luminescing near the full capacity of the luminescent structure 10 such that the indicia 48 are visible during all conditions. Since lighting conditions may vary depending on a plurality of factors including, but not limited to, the current time, date, and weather conditions, the intensity of excitation light 24 emitted from the light source 52 may be adjusted by the controller 72 such that illumination of the luminescent structure 10 may be noticed under any condition. For example, the light intensity in Florida during a clear summer afternoon will generally be higher than the light intensity in Michigan during an overcast winter morning. Thus, by making this type of information known to the controller 72, the controller 72 can adjust any light source 52.

According to various examples, the luminescent structure 10 discussed herein is substantially Lambertian, that is, the apparent brightness of the luminescent structure 10 is substantially constant regardless of an observer's angle of view. As described herein, the color of the converted light 26 may be significantly dependent on the particular luminescent materials 18 utilized in the luminescent structure 10. Additionally, a conversion capacity of the luminescent structure 10 may be dependent on a concentration of the luminescent material 18 utilized in the luminescent structure 10. By adjusting the range of intensities that may excite the luminescent structure 10, the concentration, types, and proportions of the luminescent materials 18 in the luminescent structure 10 discussed herein may be operable to generate a range of color hues of the excitation light 24 by blending the first wavelength with the second wavelength.

Referring to FIGS. 9 and 10, the emblem assembly 46 may additionally, and/or alternatively, be disposed on various portions and windows 44 of the vehicle 28. For example, as exemplarily illustrated in FIG. 9, the emblem assembly 46 may be prominently disposed on a windshield 136 of the vehicle 28. Moreover, the emblem assembly 46 may be disposed in a driver forward viewing area 138 of the windshield 136 that would be forwardly of a driver's seat 140 of the vehicle 28. The driver forward viewing area 138 may be an area that if a driver were present, the emblem assembly 46 may obstruct the driver's vision while operating the vehicle 28. Such a position may be chosen such that drivers of proximate vehicles can readily view that the vehicle 28 is under an autonomous operating mode. It will be appreciated, however, that the emblem assembly 46 may be disposed on any portion of the windshield 136 without departing from the teachings provided herein.

As exemplarily illustrated in FIG. 10, the emblem assembly 46 may additionally, and/or alternatively, be disposed on a rear portion 142, or a rear window 144, of the vehicle 28. Accordingly, vehicles and persons disposed rearwardly of the vehicle 28 may also be notified of the operational mode of the vehicle 28. As provided herein, each emblem assembly 46 may be visible and/or attached to the vehicle 28 when the vehicle 28 is in a first operational mode (e.g., an autonomous driving mode) and non-visible and/or removed from the vehicle 28 in a second operational mode (e.g., a manual driving mode).

Use of the present disclosure may offer a variety of advantages. For instance, use of the emblem assembly may provide notification of a vehicle mode, such as operating mode, of the vehicle to proximate vehicles and/or persons. The emblem assembly may incorporate a light source therein to provide lighting through a window of the vehicle, through a trim member of the vehicle, along a panel of the vehicle, and/or to a ground surface proximate the vehicle. The emblem assembly may also include a reflective material and/or a luminescent material thereon to provide additional visibility of the emblem assembly. The emblem assembly may include any or all of the features provided herein and still be manufactured at low costs when compared to standard emblems and lighting assemblies.

According to various examples, a vehicle is provided herein. The vehicle includes an emblem assembly configured to couple to a window of a vehicle. An indicia is disposed within the emblem assembly signifying a first operational mode of the vehicle. A reflective layer is disposed on the emblem assembly. The indicia has a first level of visibility when the vehicle is operating in the first operational mode and a second, lower level of visibility in a second operational mode. Examples of the vehicle can include any one or a combination of the following features:
a light source optically coupled with a light guide and configured to direct excitation light towards a luminescent structure, wherein the luminescent structure defines the indicia;
first and second light-blocking layers disposed on opposing sides of the light guide, wherein the light source emits excitation light in the UV spectrum and the first and second light-blocking layers block light in the UV spectrum from transmission therethrough;
the luminescent structure comprises at least one luminescent material configured to convert the excitation light in a non-visible spectrum received from the light source into a visible, converted light;
the first operational mode is defined by an autonomous operation of the vehicle;
the second operational mode is defined by a manual operation of the vehicle;
the emblem assembly is disposed within a driver forward viewing area of a windshield of the vehicle;
a seat sensor, wherein the indicia is non-visible when the seat sensor detects that a seat of the vehicle is occupied;
a light guide operably coupled with the indicia and the light source;
a controller configured to activate the light source when the vehicle is disposed in the first operational mode and deactivate the light source when the vehicle is operated in the second operational mode;
the indicia on the windshield is disposed vehicle forward of a driver's seat of the vehicle; and/or
the indicia is arranged to indicate an autonomous driving mode of the vehicle.

Moreover, a method of indicating an operational mode of a vehicle is provided herein. The method includes positioning an emblem assembly on a window of said vehicle. an indicia is disposed within the emblem assembly signifying a first operational mode of the vehicle. A reflective layer is overlaid on the emblem assembly. The indicia is visible when the vehicle is operating in the first operational mode and non-visible in a second operational mode.

According to some examples, an emblem assembly for a vehicle is provided herein. The emblem assembly includes an indicia signifying a first operational mode of the vehicle. A reflective layer is disposed on the indicia. The indicia is more visible when the vehicle is operating in the first operational mode and less visible in a second operational mode. Examples of the emblem assembly for a vehicle can include any one or a combination of the following features:
the indicia is defined by a luminescent structure that is substantially non-visible in an unexcited state;
the indicia luminesce while the vehicle is in an autonomous driving mode;
a seat sensor, wherein the indicia is non-visible when the seat sensor detects that a seat of the vehicle is occupied;
a reflective layer disposed on the indicia; and/or
a light guide operably coupled with the indicia.

According to other examples, an emblem assembly for a vehicle is disclosed. The emblem assembly includes a light source optically coupled to a light guide. An indicia is operably coupled with the light guide. A controller is configured to activate the light source when the vehicle is disposed in a first operational mode and deactivate the light source when the vehicle is operated in a second operational mode. Examples of the emblem assembly can include any one or a combination of the following features:
the indicia is disposed on a windshield of the vehicle;
the indicia on the windshield is disposed vehicle forward of a driver's seat of the vehicle;
the indicia is arranged to indicate an autonomous driving mode of the vehicle;
the indicia is defined by a luminescent structure that luminesces while the vehicle is in an autonomous driving mode;
the indicia is substantially non-visible in an unexcited state; and/or
the light guide includes optics that are configured to direct an excitation light emitted from the light source towards the indicia.

It will be understood by one having ordinary skill in the art that construction of the described invention and other components is not limited to any specific material. Other exemplary examples of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle, comprising:
an emblem assembly configured to couple to a window of a vehicle;
an indicia disposed within the emblem assembly signifying a first operational mode of the vehicle; and
a reflective layer disposed on the emblem assembly, wherein the indicia has a first level of visibility when the vehicle is operating in the first operational mode and a second, lower level of visibility in a second operational mode.

2. The vehicle of claim 1, further comprising:
a light source optically coupled with a light guide and configured to direct excitation light towards a luminescent structure, wherein the luminescent structure defines the indicia.

3. The vehicle of claim 2, further comprising:
first and second light-blocking layers disposed on opposing sides of the light guide, wherein the light source emits excitation light in the UV spectrum and the first and second light-blocking layers block light in the UV spectrum from transmission therethrough.

4. The vehicle of claim 2, wherein the luminescent structure comprises at least one luminescent material configured to convert the excitation light in a non-visible spectrum received from the light source into a visible, converted light.

5. The vehicle of claim 1, wherein the first operational mode is defined by an autonomous operation of the vehicle.

6. The vehicle of claim 5, wherein the second operational mode is defined by a manual operation of the vehicle.

7. The vehicle of claim 1, wherein the emblem assembly is disposed within a driver forward viewing area of a windshield of the vehicle.

8. An emblem assembly for a vehicle, comprising:
an indicia signifying a first operational mode of the vehicle; and
a reflective layer disposed on the indicia, wherein the indicia is more visible when the vehicle is operating in the first operational mode and less visible in a second operational mode.

9. The emblem assembly for a vehicle of claim 8, wherein the indicia is defined by a luminescent structure that is substantially non-visible in an unexcited state.

10. The emblem assembly for a vehicle of claim 9, wherein the indicia luminesce while the vehicle is in an autonomous driving mode.

11. The emblem assembly for a vehicle of claim 8, further comprising:
a seat sensor, wherein the indicia is non-visible when the seat sensor detects that a seat of the vehicle is occupied.

12. The emblem assembly for a vehicle of claim 11, further comprising:
a reflective layer disposed on the indicia.

13. The emblem assembly for a vehicle of claim 8, further comprising:
a light guide operably coupled with the indicia.

14. An emblem assembly for a vehicle, comprising:
a light source optically coupled to a light guide;
an indicia operably coupled with the light guide; and
a controller configured to activate the light source when the vehicle is disposed in a first operational mode and deactivate the light source when the vehicle is operated in a second operational mode.

15. The emblem assembly for a vehicle of claim 8, wherein the indicia is disposed on a windshield of the vehicle.

16. The emblem assembly for a vehicle of claim 15, wherein the indicia on the windshield is disposed vehicle forward of a driver's seat of the vehicle.

17. The emblem assembly for a vehicle of claim 14, wherein the indicia is arranged to indicate an autonomous driving mode of the vehicle.

18. The emblem assembly for a vehicle of claim 14, wherein the indicia is defined by a luminescent structure that luminesces while the vehicle is in an autonomous driving mode.

19. The emblem assembly for a vehicle of claim 14, wherein the indicia is substantially non-visible in an unexcited state.

20. The emblem assembly for a vehicle of claim 14, wherein the light guide includes optics that are configured to direct an excitation light emitted from the light source towards the indicia.
